(19) United States
(12) Patent Application Publication
(10) Pub. No.: US 2016/0349882 A1
(43) Pub. Date: Dec. 1, 2016

(54) IN-CELL TOUCH SCREEN PANEL, METHOD OF DRIVING IN-CELL TOUCH SCREEN PANEL, AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Yingming LIU, Beijing (CN); Xue DONG, Beijing (CN); Haisheng WANG, Beijing (CN); Xiaochuan CHEN, Beijing (CN); Shengji YANG, Beijing (CN); Ming YANG, Beijing (CN); Wei LIU, Beijing (CN); Hongjuan LIU, Beijing (CN); Qian WANG, Beijing (CN)

(21) Appl. No.: 15/168,667

(22) Filed: May 31, 2016

(30) Foreign Application Priority Data
Jun. 1, 2015 (CN) 201510293901.9

(51) Int. Cl. G06F 3/044

(52) U.S. Cl. CPC G06F 3/044; G06F 2203/04101

(57) ABSTRACT

An in-cell touch screen panel is disclosed. The in-cell touch screen panel includes a capacitive touch control circuit, a control module and a dermatoglyphics identification circuit. The capacitive touch control circuit is configured to determine a touch control position. The control module is configured to determine a dermatoglyphics scan region on basis of the touch control position, and send a dermatoglyphics scan signal to the dermatoglyphics identification circuit. The dermatoglyphics identification circuit is configured to scan the dermatoglyphics in the dermatoglyphics scan region to produce identification signals responsive to the dermatoglyphics scan signals, and send the identification signals to the control module. The control module processes the identification signals. A method of driving the in-cell touch screen panel and a display apparatus comprising the in-cell touch screen panel are further disclosed.

### TECHNICAL FIELD

Embodiments of the present disclosure relate to an in-cell touch screen panel, a method of driving the in-cell touch screen panel, and a display device.

### BACKGROUND

Human skin comprises an epidermis layer and a dermis layer. Epidermis nipples protrude toward to the surface of skin and form a plurality of nipple lines which are arranged orderly. The nipple lines are called ridges, and recessed portions between the ridges are called furrows. The epidermis layer of the skin of palm or finger forms various dermatoglyphics due to different arrangements of the ridges and the furrows. The term “dermatoglyphics” refers to texture pattern of particular portions of human skin.

Human dermatoglyphics is of individual characteristics. Dermatoglyphics is formed at the 14th week in embryonic development period, and will not be changed and is of high stability. In some case, such as chromosomal abnormalities, congenital diseases and so on, dermatoglyphics will be changed and can be taken as circumstantial evidence for diagnosis or a basis for preliminary selection.

Due to individual characteristics of dermatoglyphics and its change as diagnosis basis, recognition of dermatoglyphics can be adopted in identification system or in medical diagnosis system.

With rapid development of display technologies, touch screen panels have been used widely in daily life of people. Currently, touch screen panels can be classified into following categories according to their operation principles: resistive type, capacitive type, infrared type, surface acoustic wave type, electromagnetic type, vibration wave sensing type, frustrated total internal reflection optical sensitive type, or the like. Capacitive-type touch screen panel among these touch screen panels has become most popular and attractive in the industry due to its particular touch control principle, high sensitivity, long lifetime, high transmittance etc.

### SUMMARY

Embodiments of the disclosure provides an in-cell touch screen panel, a method of driving the in-cell touch screen panel and a display apparatus to reduce time and power consumption for identifying a dermatoglyphics.

At least one embodiment of the disclosure provides an in-cell touch screen panel comprising: a capacitive touch control circuit, a control module and a dermatoglyphics identification circuit, wherein the capacitive touch control circuit comprises a plurality of capacitive touch control electrodes and a touch control detection chip, the touch control detection chip is connected with each of the capacitive touch control electrodes and is configured to determine a touch control position by detecting variation of capacitance of the capacitive touch control electrodes; the control module is configured to determine a dermatoglyphics scan region on basis of the touch control position, and to transmit dermatoglyphics scan signals to the dermatoglyphics identification circuit; the dermatoglyphics identification circuit is configured to scan a dermatoglyphics in the dermatoglyphics scan region to produce identification signals responsive to the dermatoglyphics scan signals, and send the identification signals to the control module, and the control module is configured to process the identification signals.

At least one of the embodiments of the disclosure provides a display apparatus, comprising the above mentioned in-cell touch screen panel.

At least one of the embodiments of the disclosure provides a method of driving the above mentioned in-cell touch screen panel, comprising: detecting a touch control position; determining a dermatoglyphics scan region according to the touch control position; identifying dermatoglyphics in the dermatoglyphics scan region and producing an identification signal; and processing the identification signal.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic structural diagram of an in-cell touch screen panel according to an embodiment of the disclosure;

FIG. 2 is a schematic structural diagram of a dermatoglyphics identification circuit of the in-cell touch screen panel according to an embodiment of the disclosure;

FIG. 3 is a schematic structural diagram of a dermatoglyphics identification circuit of the in-cell touch screen panel according to another embodiment of the disclosure;

FIG. 4 is a schematic structural diagram of a dermatoglyphics identification circuit of the in-cell touch screen panel according to yet another embodiment of the disclosure;

FIG. 5 is a schematic structural diagram of a dermatoglyphics identification circuit of the in-cell touch screen panel according to still another embodiment of the disclosure;

FIG. 6 is a schematic structural diagram of a dermatoglyphics identification circuit of the in-cell touch screen panel according to yet still another embodiment of the disclosure;

FIG. 7 is a schematic structural diagram of an in-cell touch screen panel according to an embodiment of the disclosure; and

FIG. 8 is a flow chart of a method of driving the in-cell touch screen panel according to an embodiment of the disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

In a personality identification system based on touch screen panel for security. a method of identifying dermatoglyphics (such as fingerprint or palmprint) using a dermatoglyphics identification apparatus is used. Currently, a dermatoglyphics identification module (such as a fingerprint identification module) is usually provided on a blank region outside a display region of the touch screen panel to achieve the function of dermatoglyphics identification. The system usually needs to be operated after identifying the dermatoglyphics in detection, which is not convenient, and it is necessary to integrate a display device and a dermatoglyphics identification device during manufacturing the system, and the manufacture process becomes more complicated.

Therefore, a dermatoglyphics identification region is provided on the display region, that is, the dermatoglyphics identification and the touch function is integrated. However, in a touch screen panel, signals over all of the dermatoglyphics touch control read lines of the display region are required to be scanned and processed to identify the dermatoglyphics, and in this way a large amount of data need to be processed, and especially for a display screen with a large size, a huge large amount of data need to be processed. Consequently, it takes a longer time period and takes more power consumption to identify the dermatoglyphics.

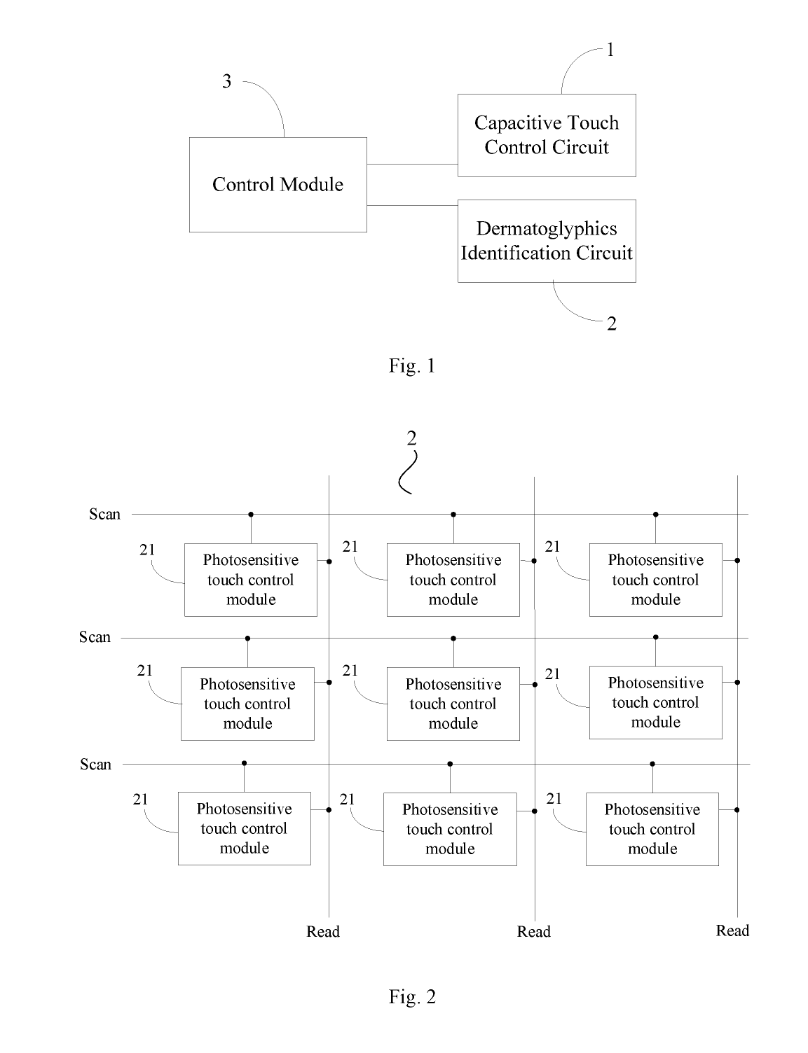

At least one of the embodiments of the disclosure provides an in-cell touch screen panel. As illustrated in FIG. 1, the in-cell touch screen panel comprises a capacitive touch control circuit 1 and the capacitive touch control circuit 1 comprises a plurality of capacitive touch control electrodes and a touch control detection chip. The touch control detection chip is connected with the capacitive touch control electrodes and is configured to determine a touch control position by detecting variation of capacitance of the capacitive touch control electrodes. The in-cell touch screen panel further comprises a dermatoglyphics identification circuit 2 and a control module 3. For example the dermatoglyphics identification circuit 2 can be used to identify fingerprint or palmprint but not limited thereto.

In an example, the dermatoglyphics identification circuit 2 comprises photosensitive touch control circuits 21 arranged in a matrix, touch control scan lines Scan that are connected with each row of photosensitive touch control circuits correspondingly, and dermatoglyphics touch control read lines Read that are connected with each column of photosensitive touch control circuits correspondingly, as illustrated in FIG. 2. The dermatoglyphics identification circuit 2 is configured to identify a dermatoglyphics in a corresponding detection region and produce identification signals through the photosensitive touch control circuits 21, and when the control module 3 outputs dermatoglyphics scan signals to the dermatoglyphics touch control scan lines Scan connected with the photosensitive touch control circuits 21, the photosensitive touch control circuits 21 output the identification signals to the dermatoglyphics touch control read lines Read.

The control module 3 are connected with the capacitive touch control circuit 1, the dermatoglyphics touch control scan lines Scan, and the dermatoglyphics touch control read lines Read respectively. The control module 3 is configured to determine a dermatoglyphics scan region according to a touch control position, after the capacitive touch control circuit 1 determines the touch control position, and for example to output a dermatoglyphics scan signal to each of the dermatoglyphics touch control scan lines Scan corresponding to the dermatoglyphics scan region and processes an identification signal output from each of the dermatoglyphics touch control read lines Read corresponding to the dermatoglyphics scan region. The control module 3 can be embodied with hardware (e.g., DSP, PLC, or CPU), firmware, software, or any combination thereof; for example the control module 3 may be implemented with a memory, a processor, and one or more modules stored in the memory, and the one or more modules comprises program instructions to realize the intended function or steps.

The above mentioned in-cell touch screen panel according to the embodiment of the disclosure comprises a capacitive touch control circuit, a dermatoglyphics identification circuit, and a control module. The capacitive touch control circuit determines a touch control position. The control module is configured to determine a dermatoglyphics scan region according to the touch control position, after the capacitive touch control circuit determines the touch control position. The dermatoglyphics identification circuit identifies a dermatoglyphics in the dermatoglyphics scan region and produces identification signals through the photosensitive touch control circuits thereof, and when the dermatoglyphics touch control scan lines connected with the photosensitive touch control circuits receive dermatoglyphics scan signals output from the touch control module, the photosensitive touch control circuit outputs the identification signals to the dermatoglyphics touch control read lines of the dermatoglyphics identification circuit. The control module reads the identification signals output from the dermatoglyphics touch control read lines and processes the signals. Thus the control module performs the dermatoglyphics touch control scan and the signal process with respect to only the dermatoglyphics scan region corresponding to the touch control position determined by the dermatoglyphics identification circuit, thus the time for dermatoglyphics touch control scanning and the mount of data to be processed can be remarkably reduced, and in turn the time and power consumption for identifying the dermatoglyphics is reduced also.

It should be noted that, in the above-mentioned in-cell touch screen panel according to the embodiment of the disclosure, the capacitive touch control circuit can be of, but not limited to, mutual capacitive type or self-capacitive type. When the capacitive touch control circuit is of mutual capacitive type, capacitive touch control electrodes comprise touch control drive electrodes and touch control sensing electrodes. When the capacitive touch control circuit is of self-capacitive type, the capacitive touch control electrodes only comprise the self-capacitive electrodes. The structure and configuration of the touch control circuit of mutual capacitive type or the touch control circuit of self-capacitive type can be embodied the same as the structure and configuration of a conventional touch control circuit of mutual capacitive type or a conventional touch control circuit of self-capacitive type, and the structure and configuration will not be elaborated herein.

During operation of the above-mentioned in-cell touch screen panel according to the embodiment of the disclosure, the dermatoglyphics scan region determined according to the touch control position can be a region where the touch control position is positioned exactly or can be a region which is slight larger than the region where the touch control position is positioned and covers the region where the touch control position is positioned. It can also be a region which falls within the region where the touch control is positioned and is slight smaller than the region where the touch control is positioned. That is to say, the dermatoglyphics scan region is proximately equal to the region where the touch control is positioned. This is not limited herein.

The above-mentioned in-cell touch screen panel according to the embodiment of the disclosure is applicable to a liquid crystal display (LCD) panel and is also applicable to an organic light emitting diode (OLED) display, e-ink display, or the like. This is not limited herein.

Further, the above-mentioned in-cell touch screen panel according to the embodiment of the disclosure further comprises: sub-pixels arranged in a matrix, gate lines located between sub-pixels of adjacent rows, and data lines located between adjacent columns of sub-pixels.

The pixel resolution of the touch screen panel is usually in millimeters order. Thus, in an embodiment of the disclosure, the capacitive touch control electrodes of the capacitive touch control circuit can be arranged on the basis of a desired touch control resolution. The resolution of the sub-pixels for displaying of the touch screen panel is usually in micrometers order. Therefore, a touch control point of the capacitive touch control circuit generally corresponds to a plurality of sub-pixels of the touch screen panel.

Further, the dermatoglyphics identification circuit is used to identify dermatoglyphics, and high accuracy is required. Thus, the touch control resolution of the dermatoglyphics identification circuit is smaller compared to the touch control resolution of the capacitive touch control circuit, and is generally larger than the resolution of the sub-pixels for displaying of the touch screen panel. Therefore, a photosensitive touch control circuit of the dermatoglyphics identification circuit can correspond to a plurality of sub-pixels. According to an embodiment of the disclosure, respective photosensitive touch control circuits can be built in respective sub-pixels, and the periodic distribution manner, the distribution density or pitch of all the photosensitive touch control circuits can be designed according to actual conditions.

The embodiments of the disclosure will be explained in details below. It should be noted that, the embodiments are described for better illustrating the disclosure, and it should not be construed as limiting the disclosure.

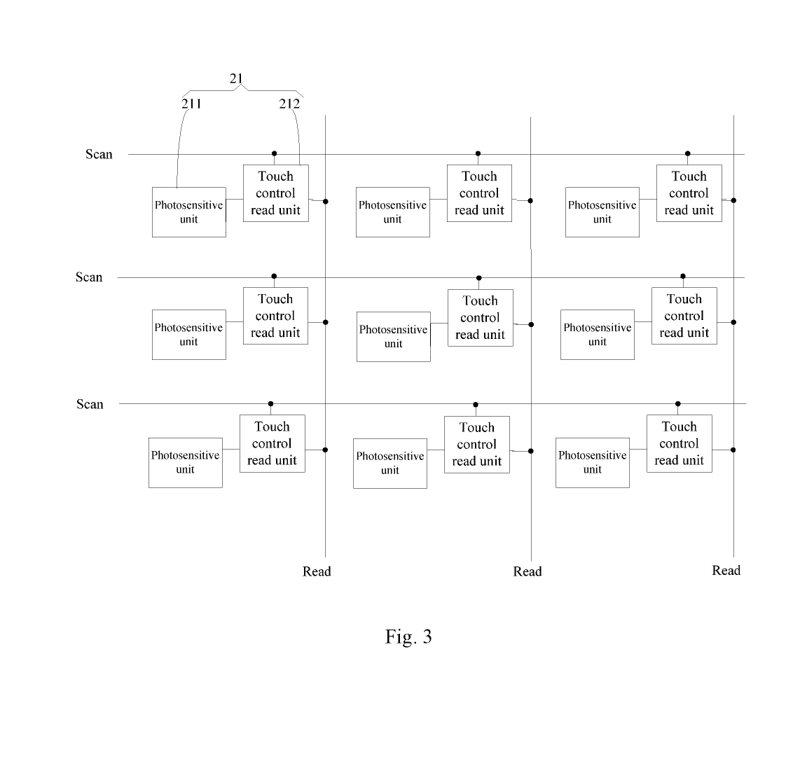

Optionally, according to the above described in-cell touch screen panel of the embodiment of the disclosure, as illustrated in FIG. 3, the photosensitive touch control circuit 21 comprises a photosensitive unit 211 and a touch control read unit 212.

An output terminal of the photosensitive unit 211 is connected with an input terminal of the touch control read unit 211, a control terminal of the touch control read unit 212 is connected with a corresponding dermatoglyphics touch control scan line Scan, and an output terminal of the touch control read unit 212 is connected with a corresponding dermatoglyphics touch control read line Read.

The photosensitive unit 211 is configured to produce an identification signal when receiving light and provide the identification signal to the input terminal of the touch control read unit 212. For example, the photosensitive unit 211 is configured to receive the light which is emitted from a light source built in the touch screen panel and is reflected to the photosensitive unit 211 by the skin of the human body touching the panel when the skin touches the touch screen panel.

The touch control read unit 212 is configured to be in on-state when the dermatoglyphics scan signal is received over the corresponding dermatoglyphics touch control scan line, and output the received identification signal to the dermatoglyphics touch control read line Read.

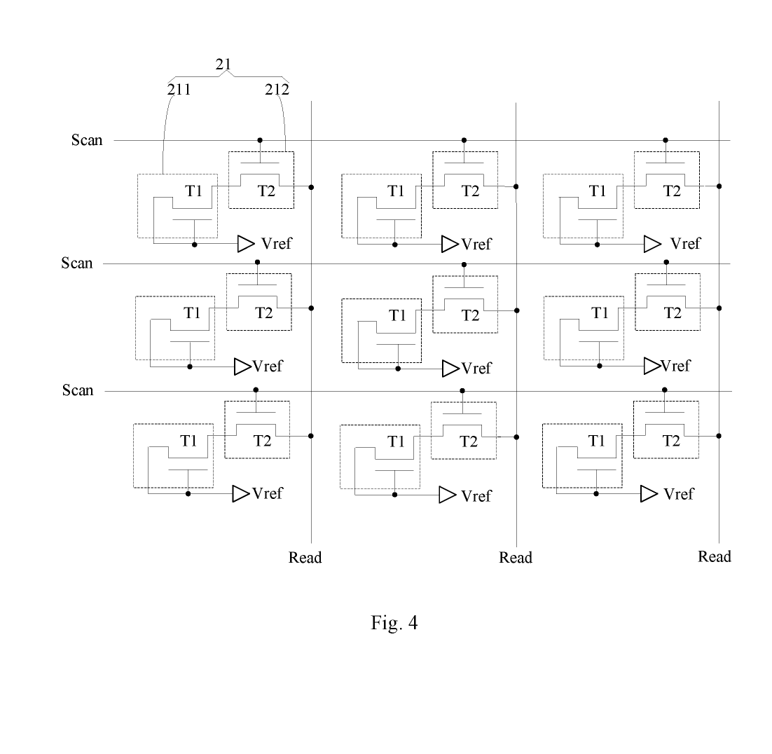

In the in-cell touch screen panel according to an embodiment of the disclosure, as illustrated in FIG. 4, an example of the photosensitive unit 211 comprises a photosensitive transistor T1; a source and a gate of the photosensitive transistor T1 are connected with a reference signal end Vref, and a drain of the photosensitive transistor T1 is used as the output terminal of the photosensitive unit 211.

The working principle of the photosensitive transistor is as follows. When the touch by a human body does not occur, light from the light source built in the touch screen panel emits out directly, and the photosensitive transistor does not receive reflected light. Thus the photosensitive transistor outputs no identification signal. When the skin of a human body touches the touch screen panel, the light from the light source built in the touch screen panel is reflected to the photosensitive transistor by the skin, and the conductive carrier concentration of the active layer of the photosensitive transistor increases because the light intensity sensed by the photosensitive transistor increases, to produce the identification signal. The photosensitive transistor outputs the identification signal to the touch control read unit. In addition, the identification signal output from the photosensitive transistor is related to intensity of light received by the photosensitive transistor. The stronger the received light, the greater the identification signal output from the photosensitive transistor to the touch control read unit is. Because the skin has an uneven dermatoglyphics, resulting in different light intensities in areas corresponding to concave and convex points of the dermatoglyphics, whether the dermatoglyphics on a corresponding area is a concave point or a convex point can be determined by determining the magnitude of the identification signal.

According to an embodiment of the disclosure, a part of components of the photosensitive transistor as the photosensitive unit can be prepared in the same layers as a part of components of switch transistors of sub-pixels of the touch screen panel. In such a way, the process for the photosensitive unit and the display panel can be achieved by only modifying a corresponding patterning for each layer, without requiring too many new processes, which saves production costs and improves production efficiency. Of course, the photosensitive unit can also have other structures, which will not be detailed here.

Further, in the in-cell touch screen panel according to an embodiment of the disclosure, the reference signal end can be connected to a common electrode, which can be grounded or not, and this is not be limited here.

In the above described in-cell touch screen panel according to an embodiment of the disclosure, the touch control read unit 212 comprises a switch transistor T2, as illustrated in FIG. 4, for example.

A source electrode of the switch transistor T2 is used as an input terminal of the touch control read unit 212, a gate electrode of the switch transistor T2 is a control terminal of the touch control read unit 212, and a drain electrode of the switch transistor T2 is used as an output terminal of the touch control read unit 212.

According to an embodiment of the disclosure, when the switch transistor T2 is converted from off-state to on-state under a control of a corresponding dermatoglyphics touch control scan line Scan, an identification signal output from the photosensitive unit 211 is output to the dermatoglyphics touch control read line Read, and the control module can carry out a dermatoglyphics identification function by processing the identification signal on the dermatoglyphics touch control read line Read.

According to an embodiment of the disclosure, respective components of the photosensitive transistor as the touch control read unit can be prepared in the same layers as respective components of a switch transistor of a sub-pixel of the touch screen panel. In such a way, for the manufacturing for the touch control read unit and the display panel, any new preparing processes may not be needed, and the in-cell touch control screen panel can be implemented by only modifying corresponding patterning of each layer, without requiring any new additional preparing processes, which saves production cost and improves production efficiency. Of course, the touch control read unit may also have other structures, which will not be elaborated here.

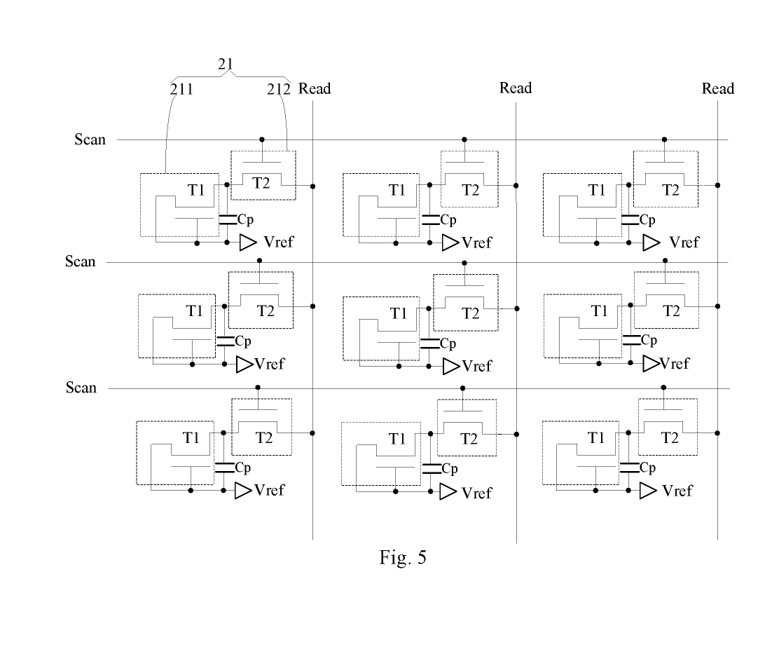

In the above described in-cell touch screen panel according to the embodiment of the disclosure, the photosensitive touch control circuit 21 may further comprise a capacitor Cp, as illustrated in FIG. 5.

A terminal of the capacitor Cp is connected with the output terminal of the photosensitive unit 211 and the input terminal of the touch control read unit 212 respectively, and another terminal of the capacitor Cp is connected with a reference signal end Vref. The capacitor Cp is configured to hold the identification signal produced by the photosensitive unit 211 on the input terminal of the touch control read unit 212 for a longer time period, in order to ensure that the touch control read unit 212 can more stably output the received identification signal to the dermatoglyphics touch control read line Read, when the dermatoglyphics scan signal is received on the corresponding dermatoglyphics touch control scan line Scan.

According to an embodiment of the disclosure, the dermatoglyphics touch control read lines can be arranged between adjacent columns of sub-pixels (for displaying) of the touch screen panel. Further, the respective dermatoglyphics touch control read lines and the respective data signal lines of the touch screen panel can be arranged in a same layer and are insulated from each other. Thus, the respective dermatoglyphics touch control read lines which are insulated from the respective data signal lines can be prepared while the respective data lines are prepared, that is, they can be formed together. In such a way, patterns of the data signal lines and patterns of the dermatoglyphics touch control read lines are formed by same one or more patterning processes when the touch screen panel is prepared, without requiring any new preparing processes, which saves preparation cost. Of course, the dermatoglyphics touch control read lines and the data signal lines can be prepared separately, and this will not be limited here.

Similarly, according to an embodiment of the disclosure, the dermatoglyphics touch control scan lines can be arranged between adjacent rows of sub-pixels of the touch screen panel. Similarly, the respective dermatoglyphics touch control scan lines and the respective gate signal lines of the touch screen panel can be arranged in a same layer and are insulated from each other. Thus, the respective dermatoglyphics touch control scan lines which are insulated from the respective gate signal lines are prepared while the respective gate lines are prepared, that is, they can be formed together. In such a way, any additional preparing processes will not be added when the touch screen panel is prepared, and patterns of the gate signal line and patterns the dermatoglyphics touch control scan line are formed by same one or more patterning processes, which saves preparation costs and promotes production additive value. Of course, the dermatoglyphics touch control scan lines and the gate signal lines can be prepared separately, and this will not be limited here.

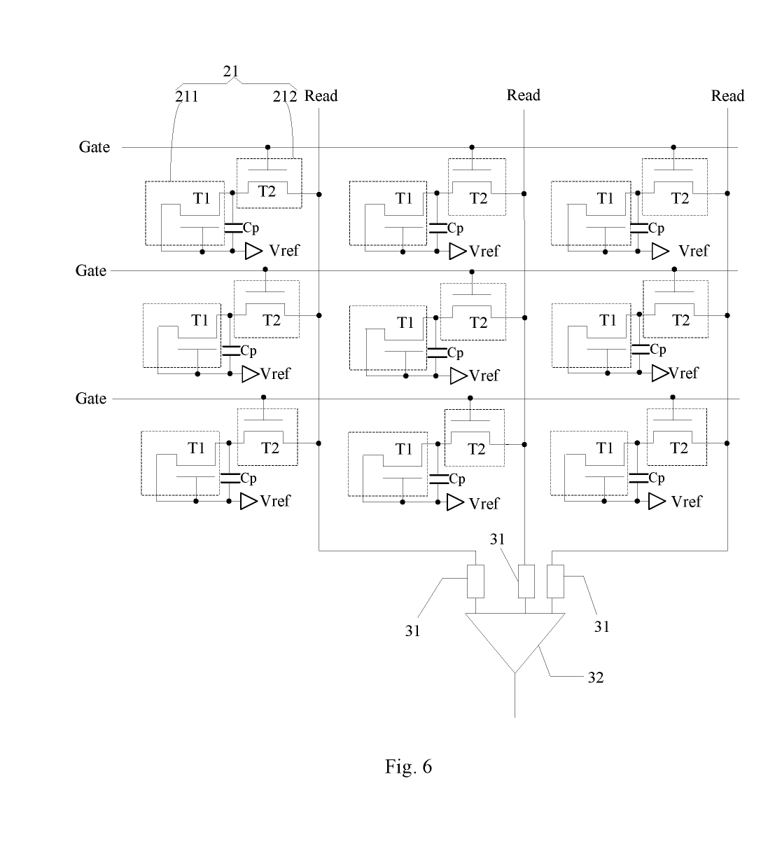

In the in-cell touch screen panel according to an embodiment of the disclosure, as illustrated in FIG. 6, at least one of the gate signal lines Gate of the touch screen panel can be used as at least one dermatoglyphics touch control scan line, which configuration can avoid arranging new wirings in the touch screen panel and will allow the touch screen panel to have a larger aperture ratio. Furthermore, in the example, the gate signal lines Gate are reused as the dermatoglyphics touch control lines, which will further avoid adding an individual driving chip IC to separately control the dermatoglyphics touch control scan lines, which saves preparation cost.

According to the in-cell touch screen panel of an embodiment of the disclosure, an example of the control module can comprise: a region determination unit, configured to determine a dermatoglyphics scan region according to a touch control position, after the touch control position is determined by the capacitive touch control circuit; a signal output unit, configured to output the dermatoglyphics scan signals to the dermatoglyphics touch control scan lines of the dermatoglyphics scan region; and a signal process unit, configured to process the identification signals output from the dermatoglyphics touch control read lines of the dermatoglyphics scan region.

According to the in-cell touch screen panel of the embodiment of the disclosure, in an example, the signal process unit is configured to compare the identification signal output from each of the dermatoglyphics touch control read lines in a determined dermatoglyphics scan region with the identification signal output from its immediately preceding adjacent dermatoglyphics touch control read line, for example, and amplify the signal difference obtained from the comparison; or, the signal process unit is configured to compare an identification signal output from each of the dermatoglyphics touch control read lines in a determined dermatoglyphics scan region with an identification signal output from its immediately following adjacent dermatoglyphics touch control read line, for example, and amplify the signal difference obtained from the comparison. Thus relative positions of a concave point and a convex point can be determined and defined.

According to an embodiment of the disclosure, for example, the signal process unit can comprise at least one differential amplifier.

In the above described in-cell touch screen panel according to the embodiment of the present disclosure, at least two adjacent dermatoglyphics touch control read lines are defined as one group, and the dermatoglyphics touch control read lines belonging to the same group are connected with a same differential amplifier through a control switch. The identification signals on the dermatoglyphics touch control read lines which are needed to be compared are selected by the control switch.

For example, taking what is illustrated in FIG. 6 as an example, all the dermatoglyphics touch control read lines Read are defined as a group, and each of the dermatoglyphics touch control read lines Read belonging to the same group is connected with a same differential amplifier 32 through a corresponding control switch 31; and different dermatoglyphics touch control read lines Read may be connected to the same differential amplifier 32 through a different control switch 31.

Further, in the above described in-cell touch screen panel according to an embodiment of the disclosure, in an example, the signal process unit is generally configured to produce a dermatoglyphics characteristic image from the identification signal on the dermatoglyphics touch control read line, and compare the produced dermatoglyphics characteristic image and a predetermined dermatoglyphics characteristic image which is prestored, so as to implement the function of identifying the dermatoglyphics.

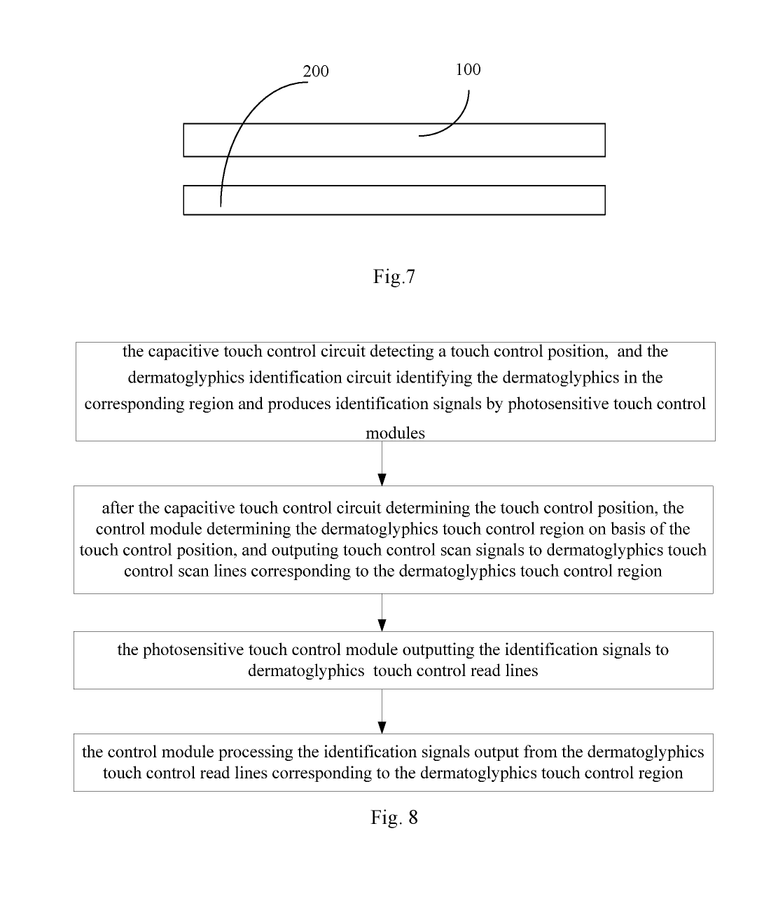

Further, in an example, the in-cell touch screen panel according to an embodiment of the disclosure comprises a backlight unit, and the backlight unit comprises a light guide plate, a light source (e.g., a dot-like light source such as an LED or a line-like light source such as a cold cathode fluorescent light), or other optical film, and is configured to provide light for the operation of the in-cell touch screen panel. As illustrated in FIG. 7, the backlight unit 200 is disposed on the side of the in-cell touch screen panel 100, which side is opposite to the side of the in-cell touch screen panel for touching. The backlight unit may be side-illuminating type or directly illuminating type.

Further, at least one embodiment of the disclosure provides a display apparatus, and the display apparatus comprises any one of the in-cell touch screen panels according to above-mentioned embodiments of the disclosure. The display apparatus may be, a cell phone, a tablet computer, a TV set, a display device, a laptop computer, a digital frame, a navigator or any product or means having a display function. Embodiments of the display apparatus can refer to above mentioned embodiments of the in-cell touch screen panel, and repeated portions will not be elaborated here. It should be noted that the in-cell touch screen panel according to the embodiments of the present disclosure can be separately applied without a function of displaying images.

At least one embodiment of the embodiments of the disclosure provides a security system, and the system comprises any one of the above in-cell touch screen panel or any one of the above display apparatus. The security system can be used for a door or gate of a warehouse or an office, a safe storage box or tank, or the like.

At least one embodiment of the embodiments of the disclosure provides a method of driving any one of the above-mentioned in-cell touch screen panel, as illustrated in FIG. 8, comprising the following operations:

The operation of detecting a touch control position, wherein a capacitive touch control circuit is configured to determine the touch control position, and a dermatoglyphics identification circuit is configured to identify a dermatoglyphics in a corresponding region and produces an identification signals through the photosensitive touch control circuit of the dermatoglyphics identification circuit.

The operation of determining a dermatoglyphics scan region from the touch control position, wherein after the capacitive touch control circuit determines the touch control position, the control module determines the dermatoglyphics scan region from the touch control position, and outputs dermatoglyphics scan signals to the dermatoglyphics touch control scan lines corresponding to the dermatoglyphics scan region.

The operation of identifying the dermatoglyphics in the dermatoglyphics scan region and producing identification signals, wherein the photosensitive touch control circuit identifies the dermatoglyphics in the dermatoglyphics scan region and produces the identification signals, and outputs the identification signals to the dermatoglyphics touch control read lines corresponding to the dermatoglyphics scan region.

The operation of processing the identification signal, wherein the control module is configured to process the identification signals output from the dermatoglyphics touch control read lines corresponding to the dermatoglyphics scan region.

The embodiments of the disclosure provide an in-cell touch screen panel, a method of driving the in-cell touch screen panel and a display apparatus. The in-cell touch screen panel comprises a capacitive touch control circuit, a dermatoglyphics identification circuit and a control module. The capacitive touch control circuit is configured to determine a touch control position. The dermatoglyphics identification circuit is configured to identify a dermatoglyphics in a corresponding region upon the touch screen panel being touched by the skin of a human body and produce identification signals by photosensitive touch control circuits, and when the dermatoglyphics scan signals are received on the dermatoglyphics touch control scan lines connected with the photosensitive touch control circuits, the photosensitive touch control circuits output the identification signal to dermatoglyphics touch control read lines. The control module is configured to determine a dermatoglyphics scan region according to a touch control position after the capacitive touch control circuit determines the touch control position, and outputs dermatoglyphics scan signals to dermatoglyphics touch control read lines corresponding to the dermatoglyphics scan region. The control module then process the identification signals output from the dermatoglyphics touch control read lines corresponding to the dermatoglyphics scan region. Thus, under control of the control module, the operations of dermatoglyphics touch control scan and the signal process are conducted with respect to only the dermatoglyphics scan region corresponding to the touch control position determined by the dermatoglyphics identification circuit, so that the time for dermatoglyphics touch control scanning and the mount of data to be processed can be reduced and in turn the time and power consumption for identifying a dermatoglyphics is further reduced.

What are described above is related to the illustrative embodiments of the disclosure only and not limitative to the scope of the disclosure. The scopes of the disclosure are defined by the accompanying claims.

This application claims the priority of Chinese Patent Application No. 201510293901.9 filed on Jun. 1, 2015, which is hereby incorporated entirely herein by reference.

What is claimed is:

1. An in-cell touch screen panel comprising: a capacitive touch control circuit, a control module and a dermatoglyphics identification circuit, wherein
the capacitive touch control circuit comprises a plurality of capacitive touch control electrodes and a touch control detection chip, the touch control detection chip is connected with each of the capacitive touch control electrodes and is configured to determine a touch control position by detecting variation of capacitance of the capacitive touch control electrodes;
the control module is configured to determine a dermatoglyphics scan region on basis of the touch control position, and to transmit dermatoglyphics scan signals to the dermatoglyphics identification circuit; the dermatoglyphics identification circuit is configured to scan a dermatoglyphics in the dermatoglyphics scan region to produce identification signals responsive to the dermatoglyphics scan signals, and send the identification signals to the control module, and the control module is configured to process the identification signals.

2. The in-cell touch screen panel according to claim 1, wherein the dermatoglyphics identification circuit comprises a plurality of photosensitive touch control circuits, a plurality of dermatoglyphics touch control scan lines, and a plurality of dermatoglyphics touch control read lines;
the photosensitive touch control circuits are arranged in a matrix, the respective touch control scan lines are connected with respective rows of photosensitive touch control circuits correspondingly, and the respective dermatoglyphics touch control read lines are connected with respective columns of photosensitive touch control circuits correspondingly.

3. The in-cell touch screen panel according to claim 2, wherein the control module are connected with the capacitive touch control circuit, the dermatoglyphics touch control scan lines, and the dermatoglyphics touch control read lines respectively, wherein
the control module is configured to output dermatoglyphics scan signals to the dermatoglyphics touch control scan lines corresponding to the dermatoglyphics scan region; the photosensitive touch control circuit outputs the identification signals to the dermatoglyphics touch control read lines upon receiving the dermatoglyphics scan signals through the dermatoglyphics touch control scan lines; and
the control module is configured to read the identification signals through the dermatoglyphics touch control read lines.

4. The in-cell touch screen panel according to claim 1, wherein each of the photosensitive touch control circuits comprises a photosensitive unit and a touch control read unit, wherein
the photosensitive unit is configured to produce an identification signal upon receiving light which is emitted from a light source and is reflected to the photosensitive unit when skin touches the touch screen panel, and provide the identification signal to the touch control read unit; and
the touch control read unit is configured to connect with a corresponding dermatoglyphics touch control scan line, and output the identification signal to the dermatoglyphics touch control read line upon the dermatoglyphics scan signal being received over the corresponding dermatoglyphics touch control scan line.

5. The in-cell touch screen panel according to claim 4, wherein the photosensitive unit comprises a photosensitive transistor, a source electrode and a gate electrode of the photosensitive transistor are connected with a reference signal end, and a drain electrode of the photosensitive transistor is configured to output the identification signal.

6. The in-cell touch screen panel according to claim 5, wherein the in-cell touch screen panel further comprises sub-pixels arranged in a matrix, and the photosensitive transistors of the photosensitive units and switch transistors of the sub-pixels are provided in a same layer.

7. The in-cell touch screen panel according to claim 6, wherein the touch control read unit comprises a switch transistor;
a source electrode of the switch transistor is configured to receive the identification signal, a gate electrode of the switch transistor is configured to receive a dermatoglyphics scan signal, and a drain electrode of the switch transistor is configured to output an identification signal.

8. The in-cell touch screen panel according to claim 7, wherein the in-cell touch screen panel further comprises sub-pixels arranged in a matrix, and the photosensitive transistors of the touch control read units and the switch transistors of the sub-pixels are provided in a same layer.

9. The in-cell touch screen panel according to claim 4, wherein
the photosensitive touch control circuit further comprises a capacitor, one terminal of the capacitor is connected with a junction between the output terminal of the photosensitive unit and the input terminal of the touch control read unit, and the other terminal end of the capacitor is connected with a reference signal end.

10. The in-cell touch screen panel according to claim 4, wherein at least one of gate signal line of the touch screen panel is configured to be at least one of dermatoglyphics touch control scan lines.

11. The in-cell touch screen panel according to claim 4, wherein the control module comprises
a region determination unit, configured to determine the dermatoglyphics scan region on basis of the touch control position;
a signal output unit, configured to output the dermatoglyphics scan signals to the dermatoglyphics touch control scan lines corresponding to the dermatoglyphics scan region; and
a signal process unit, configured to process the identification signals output from the dermatoglyphics touch control read lines corresponding to the dermatoglyphics scan region.

12. The in-cell touch screen panel according to claim 11, wherein
the signal process unit is configured to compare an identification signal output from one dermatoglyphics touch control read line corresponding to the dermatoglyphics scan region with an identification signal output from its adjacent dermatoglyphics touch control read line and to amplify a signal difference therebetween.

13. The in-cell touch screen panel according to claim 12, wherein the signal process unit comprises at least one differential amplifier, and the at least one differential amplifier is configured to amplify the signal difference.

14. The in-cell touch screen panel according to claim 13, wherein at least two adjacent dermatoglyphics touch control read lines are connected with a same differential amplifier by a control switch.

15. A display apparatus, comprising the in-cell touch screen panel of claim 1.

16. A method of driving an in-cell touch screen panel, comprising:
detecting a touch control position on the in-cell touch screen panel touched by skin;
determining a dermatoglyphics scan region from the touch control position;
identifying the dermatoglyphics in the dermatoglyphics scan region and producing identification signals; and
processing the identification signals.

17. The method according to claim 10, wherein the dermatoglyphics scan region is a region where the touch control position is positioned.

18. The method according to claim 17, wherein an operation of identifying the dermatoglyphics in the dermatoglyphics scan region and producing the identification signals comprises:
identifying the corresponding position to be a ridge or a furrow of dermatoglyphics, according to different light intensities on the touch control position.

19. The method according to claim 16, wherein the identification signals are output in an array of a matrix, and adjacent identification signals are compared and a comparison result is amplified, to determine relative positions of the ridge and the furrow.

20. The method according to claim 16, further comprising:
producing a dermatoglyphics characteristic image according to the identification signals and comparing a produced dermatoglyphics feature image with a predetermined dermatoglyphics feature graph.
